(19) United States
(12) Patent Application Publication
(10) Pub. No.: US 2009/0316937 A1
(43) Pub. Date: Dec. 24, 2009

(54) MONOLITHIC MICRO MAGNETIC DEVICE

(75) Inventors: Jun Zheng, Edina, MN (US); Song S. Xue, Edina, MN (US); Pat J. Ryan, St. Paul, MN (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/142,844

(22) Filed: Jun. 20, 2008

(51) Int. Cl. H04R 1/00

(52) U.S. Cl. 381/182; 381/396

(57) ABSTRACT

A micro magnetic device having a body defining at least part of an enclosed chamber, a pole comprising a soft magnetic material within the chamber, and an electrically conductive coil positioned around the pole. A diaphragm integral with the body defines a top of the chamber opposite the pole. The diaphragm supports a permanent magnetic film. Multiple micro magnetic devices can be combined to form an array. The micro magnetic device may be, for example, a speaker or a sensor. The micro magnetic device may be made by MEMS or thin film techniques.

### BACKGROUND

Speakers are acoustical elements that are common is today's society. Speakers are present in radios, stereo systems, televisions, computers, earphones/headphones and other personal equipment that is configured to emit sound. Without speakers, one could not enjoy music, a television program, or a movie, to its full extent.

A typical human ear can hear sound at a frequency bandwidth from about 20 Hz to about 20 kHz.

A traditional speaker (also referred to as a loud speaker or variation thereof) has a large magnet in close proximity to a movable current coil which drives a cone/diaphragm. The oscillating cone/diaphragm generates sound. A single loud speaker, however, typically does not have sufficient frequency bandwidth to amplify an audio signal at the full bandwidth. To expand the overall bandwidth of a speaker system, a multi-speaker system is compiled where each speaker is responsible for a limited bandwidth range. This type of system consumes a large amount of power, occupies larger space and is expensive. This issue also exists in headphones or earphones products.

Attempts have been made to miniaturize speakers using micro-system technology (MST). Although low cost and good reproducibility of electronic circuitry has been obtained, the number of realized loudspeakers using MST is small and these loudspeakers generally do not fulfill the requirements for a hearing instrument such as headphone or earphones. Better micro-speakers and methods of making them are needed.

### BRIEF SUMMARY

The present disclosure is directed to monolithic micro magnetic devices (e.g., micro-speakers, acoustic signal detection sensors) suitable for use with a broadband acoustic range. The micro magnetic devices can be made by batch microfabrication processing using thin film or micro-electromechanical system (MEMS) techniques. A plurality of the monolithic elements can be provided as an array to provide a broader bandwidth of acoustic range.

In one exemplary embodiment, this disclosure provides a micro magnetic device having a body defining at least part of an enclosed chamber, a pole comprising a soft magnetic material within the chamber, and an electrically conductive coil positioned around the pole. A diaphragm integral with the body defines a top of the chamber opposite the pole. The diaphragm supports a permanent magnetic film. Multiple micro magnetic devices can be combined to form an array.

In another exemplary embodiment, this disclosure provides a method of making a micro magnetic device by forming a first portion by providing a first silicon substrate, applying a soft magnetic material onto the silicon substrate to form a central pole, and applying an electrically conductive coil around the pole. The method includes forming a second portion by providing a second silicon substrate, applying a permanent magnetic material onto the second silicon substrate and forming a cavity or void in the second silicon substrate; this may be opposite the permanent magnetic material. Then, the first portion and the second portion are bonded, thus forming a chamber having the conductive coil and pole in an interior of the chamber with the permanent magnetic material external to the chamber. The soft magnetic material may be applied onto the silicon substrate by depositing or plating a ferromagnetic material. The permanent magnetic material may be applied onto the second substrate by depositing, plating, or printing a magnetic particle and polymer composition, and, may be applied before or after forming the cavity or void.

### BRIEF DESCRIPTION OF THE DRAWING

The invention may be more completely understood in consideration of the following detailed description of various embodiments of the invention in connection with the accompanying drawing, in which:

FIG. 1 is a schematic cross-sectional view of a micro magnetic device according to this disclosure;

FIG. 1A is an enlarged view of a portion of the micro magnetic device of FIG. 1;

FIG. 1B is an enlarged view of a portion of an alternative embodiment of a micro magnetic device;

FIG. 2 a schematic cross-sectional view of an alternate micro magnetic device according to this disclosure;

FIG. 3 is a schematic top view of an array of micro magnetic devices according to this disclosure;

FIG. 4 is a graphical representations of peak frequency/bandwidth versus amplitude for multiple micro-speakers according to this disclosure;

FIGS. 5A-5C are schematic cross-sectional views of a process for making a first half of a micro magnetic device;

FIGS. 6A-6C are schematic cross-sectional views of a process for making a second half of a micro magnetic device; and

FIGS. 7A and 7B are schematic cross-sectional views of a process for combining the first half of FIGS. 5A-5C with the second half of FIGS. 6A-6C to form a micro magnetic device.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present invention. The following detailed description, therefore, is not to be taken in a limiting sense.

The present invention is directed to miniaturized, micro magnetic devices such as micro-speakers or acoustic signal detection sensors. The elements can be used in high performance speaker devices, such as headphone or earphone devices, or in acoustic signal detection devices. The applications for the micro magnetic devices are not limited to entertainment or other audible uses, but can also include applications above that audible by humans (i.e., above about 20 kHz) such as military, biomedical and marine uses. For example, the elements could be used in sonar devices for military applications, ultrasonic devices for medical applications, or in underwater sonar or acoustical devices. The micro magnetic devices may either emit signals (e.g., sound) or sense signals.

The micro magnetic devices of this invention are built on a single semiconductor chip using micro magnetic actuator technology (e.g., thin film or MEMS techniques). An array of micro magnetic devices can be built on a single chip. In an array, each micro element covers a predefined bandwidth based on its unique physical and mechanical structure. A combination of a plurality of micro elements can offer broad bandwidth coverage for any audio signal which is delivered or received.

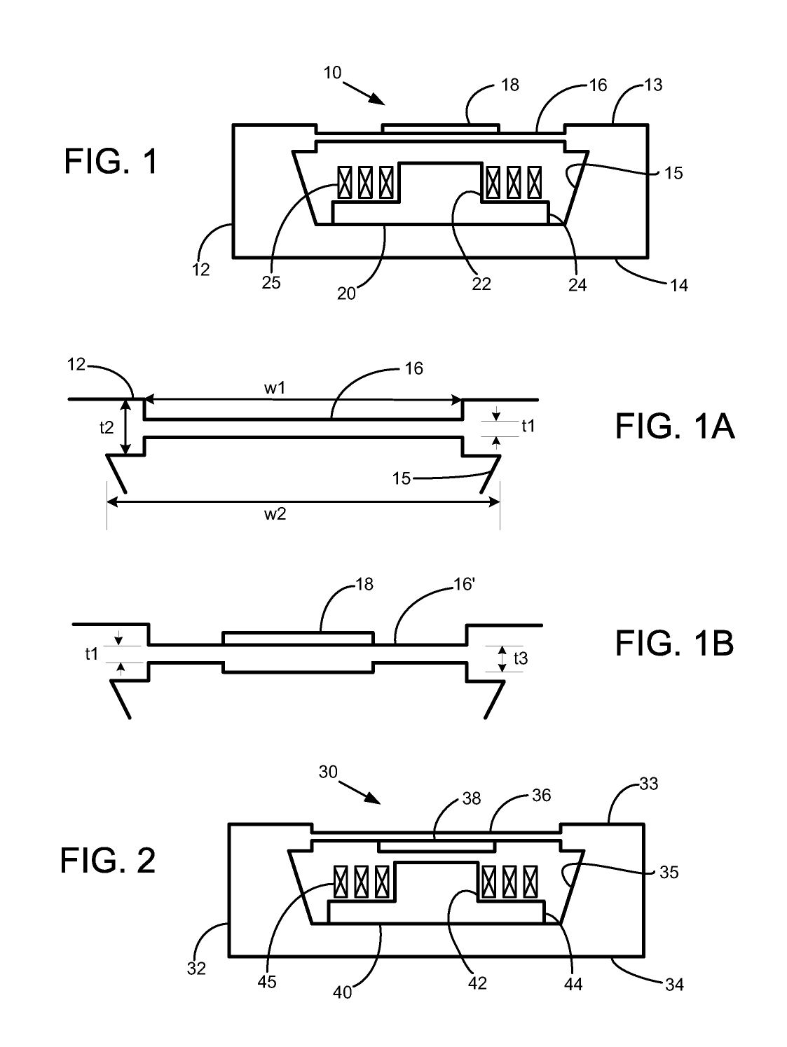

While the present invention is not so limited, an appreciation of various aspects of the invention will be gained through the discussion provided below. A specific embodiment of a micro magnetic device according to this invention is illustrated in FIG. 1 as micro-speaker 10. It should be understood that although the following discussion will be directed to a micro-speaker, the micro magnetic device could alternately be a micro sensor or the like.

The micro magnetic device micro-speaker 10 has a body 12 that forms the overall shape of micro-speaker 10. FIG. 1 is a side view of micro-speaker 10, showing a top surface 13 and an opposite bottom surface 14. It is understood that speaker 10 may be overturned so that surface 13 is physically positioned below surface 14 without departing from the scope of this disclosure, however, as used in this description, surface 13 will be referred to as the top surface and surface 14 will be referred to as the bottom surface. From a top view, micro-speaker 10 may be circular or rectangular (e.g., square), although in most embodiments, is circular.

In most embodiments, micro-speaker 10 and other micro magnetic devices of this invention are no more than about 5 mm in their largest dimension. For a circular micro magnetic device, the largest dimension is usually the diameter across top surface 13. In other embodiments, micro magnetic devices of this invention have a largest dimension of no more than about 2 mm, and often, about 1 mm in largest dimension.

Body 12 may be a dielectric material (for example, a polyamide or polyimide material), a metal, or other semiconductor or chip material. Silicon (Si) is a common material for body 12. Body 12 at least partially defines an enclosed inner chamber 15. Chamber 15 is defined by body 12 and a diaphragm 16 extending across chamber 15 proximate top surface 13. Diaphragm 16 is integral with body 12, in that diaphragm 16 is an extension of body 12 and is formed from the same material as body 12.

Present proximate diaphragm 16 is a magnetic thin film 18; in this embodiment, magnetic thin film 18 is positioned on diaphragm 16 on the side external to chamber 15. In some embodiments, a layer maybe interposed between diaphragm 16 and magnetic thin film 18. Magnetic thin film 18 is a hard or permanent magnet, the magnetization orientation of which does not change. Examples of permanent magnet materials include iron (Fe), chromium (Cr), cobalt (Co), nickel (Ni), platinum (Pt), vanadium (V), manganese (Mn), bismuth (Bi), and combinations thereof. Magnetic thin film 18 may be made of bulk material or may be electrochemical deposited (e.g., plated). In most embodiments, magnetic thin film 18 is about 1 to 200 micrometers thick, and may be thicker or thinner than diaphragm 16 which supports it. In some embodiments, magnetic thin film 18 is about 1 to 100 micrometers thick. An advantage of plating magnetic thin film 18 is the capability for decreased dimensions of magnetic thin film 18 and thus speaker 10.

During use of speaker 10, the suspended combination of diaphragm 16 and magnetic thin film 18 oscillates in a vertical direction, toward and away from chamber 15, at a frequency to produce sound waves. Through different designs of diaphragm 16, the bandwidth of micro-speaker 10 can be adjusted for a desired frequency range. The peak frequency (fₚₑₐₖ) for micro-speaker 10 is dependent on the thickness of diaphragm 16, the width of diaphragm 16, and also the Young's Modulus of diaphragm 16. Thus, the physical design of diaphragm 16 affects the bandwidth and peak frequency of speaker 10.

Diaphragm 16, which oscillates, is fairly thin, typically about 1 to 100 micrometers thick. In some embodiments, including that illustrated in FIG. 1, diaphragm 16 has a thickness that varies across chamber 15. In this embodiment, illustrated enlarged in FIG. 1A, diaphragm 16 has a thickness t1 for width or diameter w1. Chamber 15 has a width or diameter w2. Diaphragm 16, in this embodiment, does not extend across the entire chamber width w2, but rather, a portion of body 12 having a thickness t2 extends over chamber 15 and transitions into diaphragm 16 having thickness t1. The difference between w1 and w2, and the difference between t1 and t2, will also affect the peak frequency for speaker 10. In most embodiments, diaphragm 16 has a diameter about 0.5 to 2 mm across.

An alternate geometry of diaphragm 16′, for which the thickness varies across its radius, is illustrated in FIG. 1B. In this embodiment, diaphragm 16′ is thickened in the area proximate magnetic thin film 18 from thickness t1 to a thickness t3. This may be preferred, in some embodiments, due to the higher magnetic flux density on diaphragm 16 proximate magnetic thin film 18 than at the edges. In the illustrated embodiment, diaphragm 16′ is thickened in the area immediately proximate magnetic thin film 18, with the thickened area having the same shape and area as magnetic thin film 18. In other embodiments, the thickened area may be smaller, larger, or a different shape than magnetic thin film 18.

Returning to FIG. 1, positioned within chamber 15 is a magnetic material 20, which in this embodiment forms a pole 22 and a return yoke 24. In some embodiments, magnetic material 20 may form pole 22, with no yoke 24 present. Magnetic material 20 is a soft magnetic material with high momentum, the magnetization of which can be altered by being exposed to a magnetic field. Examples of soft magnetic materials include ferromagnetic materials such as nickel, iron, cobalt, iron oxide and combinations thereof. In this illustrated embodiment, magnetic material 20 is present on an interior surface of inner chamber 15; in alternate embodiments, magnetic material 20 may be recessed into body 12, i.e., the lower edge of magnetic material 20 is below the lower wall of chamber 15.

An electrically conducting coil 25 is positioned around pole 22. Coil 25 is formed from an electrically conducting material, typically metal. Examples of suitable metals for coil 25 include copper (Cu), aluminum (Al), silver (Ag) and gold (Au). In FIG. 1, coil 25 is illustrated being a single layer with three turns; other designs for a coil may be useful, such as more or less turns, or multiple layers. Coil 25 may have, for example, from one to 100 (one hundred) turns around pole 22.

In use, an electrical current is applied to coil 25. The current in coil 25 will generate a magnetic field and polarize (e.g., charge) soft magnetic material 20 of pole 22. The total magnetic field from magnetic material 20 will produce an attraction or repelling force on magnetic thin film 18 at diaphragm 16. This force will drive diaphragm 16 toward and away from pole 22 (e.g., down and up), thereby creating waves (e.g., sound waves).

An alternate embodiment of a micro magnetic device according to this invention is illustrated in FIG. 2 as micro-speaker 30. Unless otherwise indicated, the general features of the various elements of micro-speaker 30 are similar or the same as for micro-speaker 10.

The micro magnetic device micro-speaker 30 has a body 32 (e.g., a dielectric material) that forms the overall shape of micro-speaker 30 and defines a top surface 33 and an opposite bottom surface 34. Body 32 at least partially defines an enclosed inner chamber 35. Chamber 35 is defined by body 32 and a diaphragm 36 extending across chamber 35 proximate top surface 33.

Present proximate diaphragm 36 is a magnetic thin film 38; in this embodiment, magnetic thin film 38 is positioned on diaphragm 36 on the side internal to chamber 35. In some embodiments, a layer maybe interposed between diaphragm 36 and magnetic thin film 38. Magnetic thin film 38 is a hard or permanent magnet, the magnetization orientation of which does not change.

As with speaker 10, during use of speaker 30, the suspended combination of diaphragm 36 and magnetic thin film 38 oscillates in a vertical direction, toward and away from chamber 35, at a frequency to produce sound waves. Through different designs of diaphragm 36, the bandwidth of micro-speaker 10 can be adjusted for a desired frequency range.

Also within chamber 35 is a soft magnetic material 40, which in this embodiment forms a pole 42 and a return yoke 44. In some embodiments, magnetic material 40 may form pole 42, with no yoke 44 present. An electrically conducting coil 45 is positioned around pole 42.

The micro magnetic devices of this invention have a benefit over other micro magnetic devices (e.g., speakers) at least because of the position of the permanent magnet (e.g., magnetic thin film 18, 38) and the soft magnet (e.g., pole 22, 42 and yoke 24, 44). By having the permanent magnetic material proximate the diaphragm and thus moveable in relation to the coil, two separate functions occur in speaker 10, 30. Diaphragm 16, 36 has a purely mechanical function, oscillating at a frequency to produce sound. Magnetic thin film 18, 38 has a purely magnetic function, providing the force to move diaphragm 16, 36 from soft magnetic material 20, 40. Because of these two independent functions from two separate elements, speaker 10, 30 is easy to optimize.

The micro magnetic devices of this invention have a single polarity, because of the single permanent magnet (e.g., magnetic thin film 18, 38). Because the permanent magnet is positioned on the membrane, the membrane is capable of a larger deflection, thus creating a higher force dynamic range, which in turn provides a higher amplitude with a given current for the micro magnetic device.

As mentioned above, the micro magnetic devices can be used as speaker devices or in acoustic signal detection devices. The micro magnetic devices may either emit signals (e.g., sound) when in an active or actuation mode, or may sense signals when in a passive mode. In a passive mode, if any movement happens on diaphragm 16, 36 or magnetic film 18, 38, Lorentz current will be generated in coil 25, 45. This current signal can be measured from outside of the micro magnetic device.

As mentioned above, a plurality of micro magnetic devices may be combined to form an array of micro magnetic devices on a single chip. FIG. 3 illustrates an array 50 of micro-speakers, in particular, twenty speakers that include speakers 10A, 10B, 10C, 10D, 10E and 10F. In array 50, each micro-speaker 10A, 10B, 10C, 10D, 10E, 10F, etc. has a predefined bandwidth based on its unique physical and mechanical structure. In some embodiments, each micro-speaker 10A, 10B, 10C, 10D, 10E, 10F, etc. has the same diaphragm thickness but a different diaphragm width, thus providing different frequency peaks. Together, micro-speakers 10A, 10B, 10C, 10D, 10E, 10F, etc. provide broad bandwidth coverage.

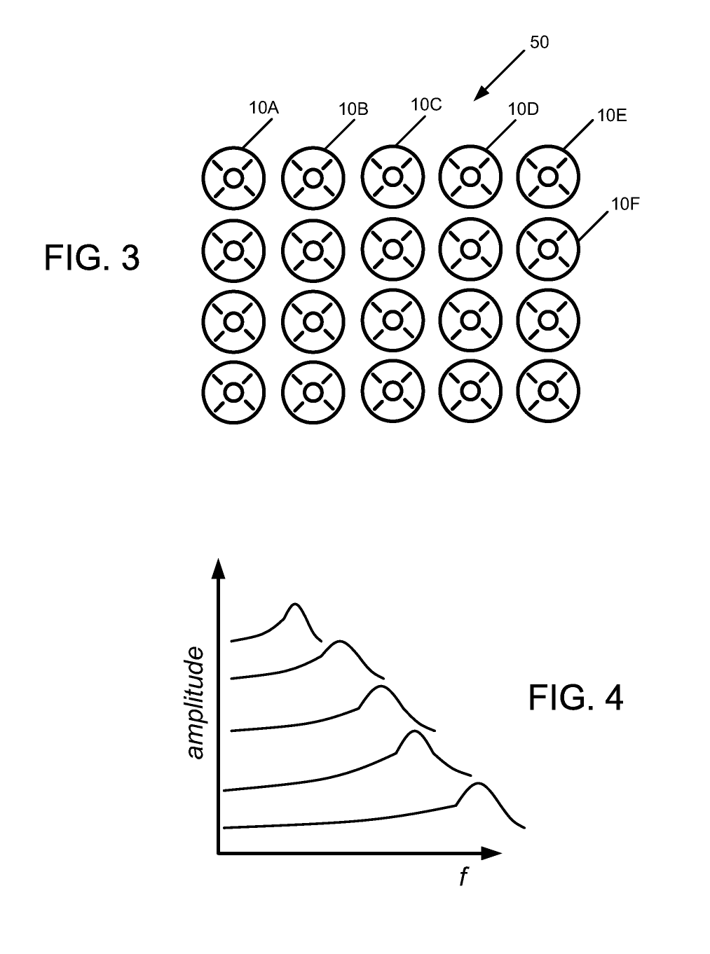

FIG. 4 graphically illustrates multiple individual bandwidths, each from a single speaker, and their distribution over a broad frequency range. It provides a generic frequency distribution for five different speakers, which differ in their membrane configuration (e.g., have a thicker or more resistant membrane), which require a higher amount of energy to drive the membrane but that provide a broader frequency bandwidth. With micro magnetic devices of this invention, the total sound wave spatial distribution can be controlled at each individual unit (e.g., speaker 10A, 10B, etc. of FIG. 3) to obtain the desired frequency peak and frequency bandwidth with minimum power usage.

The micro magnetic devices of this invention, such as micro-speaker 10, are easy to optimize to the desired frequency bandwidth. As mentioned above, the peak frequency and the bandwidth are dependent on the geometry of diaphragm 16, which can be readily designed and manufactured using micro magnetic actuator technology (e.g., thin film or MEMS techniques). Based on this technology, sound can be tuned or directed to the designated direction with higher acoustic power density. Similarly, the micro magnetic devices of this invention, such as micro-speaker 10, can be used to detect acoustic signal strength across the device, and also the phase distribution across the device, (i.e. this device can determine the direction of the signal or sound).

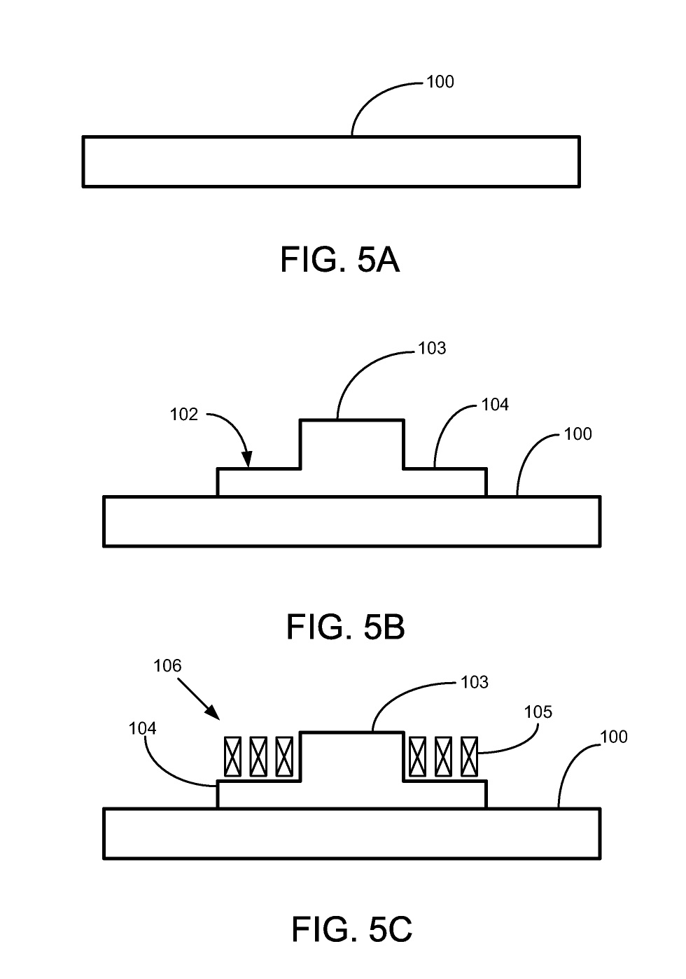

One general method of making a micro magnetic device is illustrated in FIGS. 5A-5C, 6A-6C, and 7A-7B.

In FIGS. 5A through 5C, a first portion of a micro-speaker is step-wise manufactured. If referring to micro-speaker 10 of FIG. 1, this first portion is the lower or bottom portion of speaker 10. A starting support 100 is illustrated in FIG. 5A. In many embodiments, support 100 is silica. In FIG. 5B, applied onto support 100 is a soft ferromagnetic material 102, which will form the eventual pole and return yoke of the speaker (e.g., pole 22 and yoke 24 of speaker 10). Soft ferromagnetic material 102 may be plated (e.g., electroplated), deposited (e.g, CVD, PVD, sputtered), or screen printed from a slurry of ferromagnetic particles in a binder material. In the illustrated embodiment, the stepped yoke is formed by two steps: the first step forms the return yoke 104 and the second step forms the pole 102. An electrically conductive coil 105 is positioned around pole 103 in FIG. 5C. Coil 105 may be previously produced and physically placed around pole 103, or coil 105 may be fabricated (e.g., plated or deposited) around pole 103. The result is first portion 106.

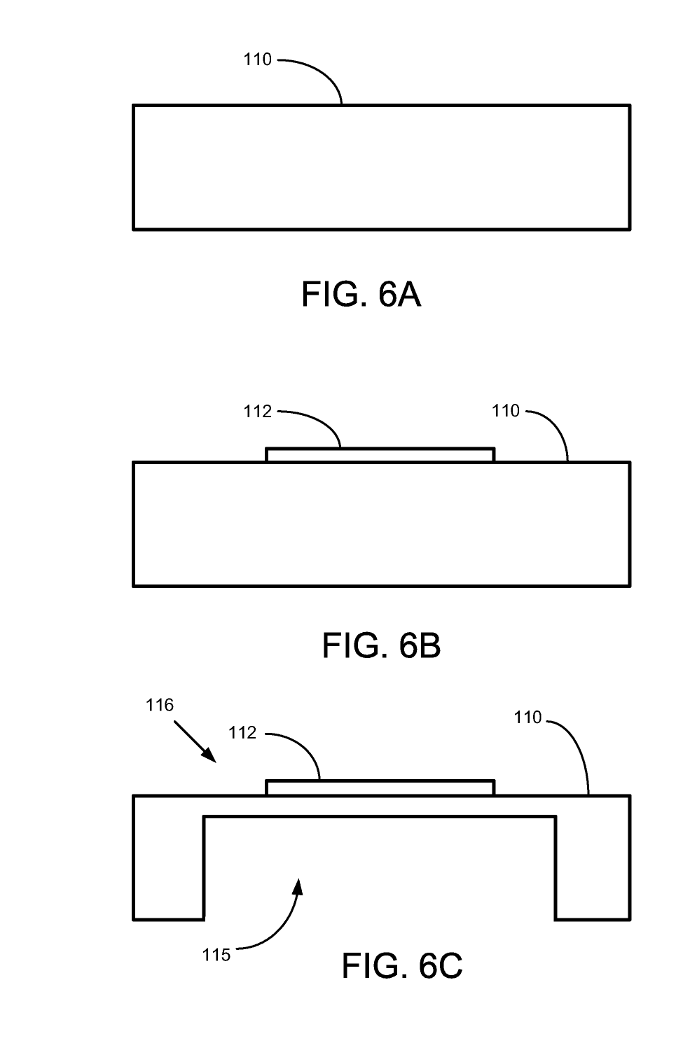

In FIGS. 6A through 6C, a second portion of a micro-speaker is step-wise manufactured. If referring to micro-speaker 10 of FIG. 1, this second portion is the top or upper portion of speaker 10. A starting support 110 is illustrated in FIG. 6A. In many embodiments, support 110 is silica. In FIG. 6B, applied onto support 110 is a hard or permanent ferromagnetic material 112, which will form the eventual magnetic thin film of the speaker (e.g., magnetic thin film 18 of speaker 10). Hard ferromagnetic material 112 may be plated (e.g., electroplated), deposited (e.g, CVD, PVD, sputtered), or screen printed from a slurry of ferromagnetic particles in a binder material. A cavity 115 is formed in support 110 that will form the eventual inner chamber of the speaker (e.g., chamber 15 of speaker 10 in FIG. 1). Support 110 may be etched away by conventional thin film etching processes to form cavity 115, or, substrate 110 may be built-up. The result is second portion 116.

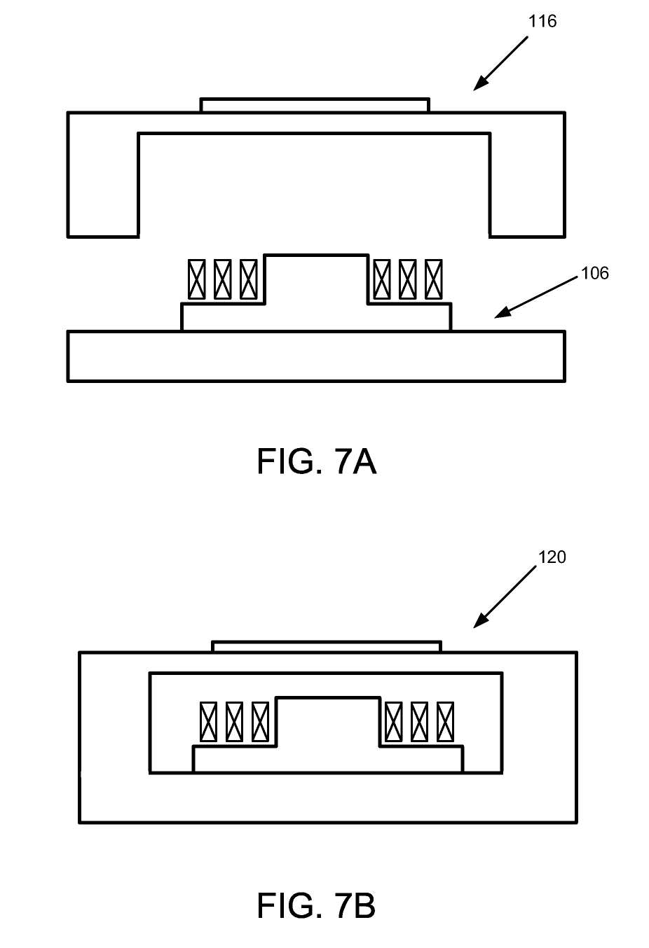

In FIG. 7A, first portion 106 from FIG. 5C is joined to second portion 116 from FIG. 6C. This may be done by wafer bonding, under the application of heat and/or pressure. In some embodiments, an adhesive or solder material may be used to facilitate the bonding. The resulting micro-speaker is illustrated in FIG. 7B as speaker 120.

It is understood that variations can be made in the apparatus and method of this invention. The various components of the micro magnetic device may take various forms. For example, in FIG. 1, inner chamber 15 of speaker 10 is illustrated as a cone-shape, tapering outward toward diaphragm 16 and magnetic film 18; in FIG. 7B, the inner chamber is illustrated as having a constant diameter. Also, for example, in FIG. 1 and FIG. 1A, diaphragm 16 has a varying thickness across the diameter of speaker 10; in FIG. 1B, diaphragm 16′ is thicker in the region immediately below the magnetic film 18; in FIG. 7B, the diaphragm has a constant thickness across the diameter of speaker 120. Also, for example, in FIG. 1, magnetic film 18 is positioned on a recessed portion of diaphragm 16, where as in FIG. 7B, the magnetic film is positioned on a planar diaphragm. Depending on the configuration of the micro magnetic device, the method of manufacturing the device may differ. For example, to make speaker 30 of FIG. 2, it may be beneficial to form a cavity in a substrate prior to depositing the thin magnetic film 3 8.

Thus, embodiments of the MONOLITHIC MICRO MAGNETIC DEVICE are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A micro magnetic device comprising:
a body defining at least part of an enclosed chamber;
a pole comprising a soft magnetic material within the chamber;
an electrically conductive coil positioned around the pole; and
a diaphragm integral with the body defining a top of the chamber opposite the pole, the diaphragm supporting a permanent magnetic film.

2. The micro magnetic device of claim 1 further comprising a yoke comprising the soft magnetic material, the yoke proximate the coil and with the pole centrally positioned in relation to the yoke.

3. The micro magnetic device of claim 2 wherein the yoke and pole are integral with each other.

4. The micro magnetic device of claim 1 wherein the body comprises silicon.

5. The micro magnetic device of claim 1 having a largest dimension of no greater than about 2 mm.

6. The micro magnetic device of claim 1 wherein the diaphragm has a thickness of about 1 to 100 micrometers.

7. The micro magnetic device of claim 1 wherein the diaphragm has a width of about 0.5 to 2 mm.

8. The micro magnetic device of claim 1 wherein the permanent magnetic film is positioned on the diaphragm external to the chamber.

9. The micro magnetic device of claim 1 wherein the permanent magnetic film is positioned on the diaphragm internal to the chamber.

10. The micro magnetic device of claim 1 wherein the permanent magnetic film has a thickness of about 1 to 200 micrometers.

11. The micro magnetic device of claim 1 wherein the permanent magnetic film comprises iron, chromium, cobalt, nickel, platinum, vanadium, manganese, bismuth, or combinations thereof.

12. The micro magnetic device of claim 1 wherein the coil comprises 1 to 100 turns around the pole.

13. An array of micro magnetic devices comprising:
(a) a first micro magnetic device comprising:
a body defining at least part of an enclosed chamber;
a pole comprising a soft magnetic material within the chamber;
an electrically conductive coil positioned around the pole; and
a diaphragm integral with the body defining a top of the chamber opposite the pole, the diaphragm supporting a permanent magnetic film, the diaphragm having a first thickness and a first dimension; and
(b) a second micro magnetic device comprising:
a body defining at least part of an enclosed chamber;
a pole comprising a soft magnetic material within the chamber;
an electrically conductive coil positioned around the pole; and
a diaphragm integral with the body defining a top of the chamber opposite the pole, the diaphragm supporting a permanent magnetic film, the diaphragm having a second thickness and a second dimension,
wherein the second dimension is different than the first dimension.

14. The array of claim 13, wherein the second thickness is the same as the first thickness.

15. The array of claim 13 wherein the permanent magnetic films are positioned on the diaphragms external to the chambers.

16. The array of claim 13 wherein the permanent magnetic films are positioned on the diaphragms internal to the chambers.

17. The array of claim 13, further comprising a third micro magnetic device, the third device comprising:
a body defining at least part of an enclosed chamber;
a pole comprising a soft magnetic material within the chamber;
an electrically conductive coil positioned around the pole; and
a diaphragm integral with the body defining a top of the chamber opposite the pole, the diaphragm supporting a permanent magnetic film, the diaphragm having a third thickness and a third dimension,
wherein the third dimension is different than the first dimension and the second dimension.

18. The array of claim 17, wherein the third thickness is the same as the first thickness and the second thickness.

19. A method of making a micro magnetic device, the method comprising:
(a) forming a first portion by:
providing a first silicon substrate;
applying a soft magnetic material onto the silicon substrate, the magnetic material forming a central pole;
applying an electrically conductive coil around the pole;
(b) forming a second portion by;
providing a second silicon substrate;
applying a permanent magnetic material onto the second silicon substrate;
forming a void in the second silicon substrate; and
(c) bonding the first portion and the second portion, thus forming a chamber having the conductive coil and pole in an interior of the chamber.

20. The method of claim 19 wherein the step of forming a void in the second silicon substrate comprises removing a portion of the second silicon substrate opposite the permanent magnetic material.
